(19) United States
(12) Patent Application Publication
(10) Pub. No.: US 2006/0122843 A1
(43) Pub. Date: Jun. 8, 2006

(54) Electronic customs release slip (E-CRS)

(75) Inventors: Hsiu-Chu Lin, Hsin-Chu (TW); Yi-Sung Lin, Hsin-Chu (TW); Chi-Wen Lin, Hsin-Chu (TW); John Kao, Taipei (TW)

Correspondence Address: THOMAS, KAYDEN, HOSTEMEYER & RISLEY LLP, 100 GALLERIA PARKWAY, SUITE 1750, ATLANTA, GA, 30339, US

(73) Assignee: Taiwan Semiconductor Manufacturing Company

(21) Appl. No.: 10/058,474

(22) Filed: Jan. 28, 2002

(51) Int. Cl. G06Q 99/00

(52) U.S. Cl. 705/1

(57) ABSTRACT

A computer controlled system and method of using the system for control of shipping a quantity of product either domestically or internationally. The system comprises a number of user input stations for entering a shipping request. Product release information stored in the computer is added to the request which is transmitted t a product storage unit, a printer, and an exit control station. The product storage unit selects the product requested. The printer prints a product release form which can include a customs declaration form and/or a digital authentication stamp if desired. The product is prepared for shipping and the product release form is attached. The product and the product release form is checked at the exit control station. The product is then shipped or corrective action is taken.

### BACKGROUND OF THE INVENTION

(1) Field of the Invention

This invention relates to a system and method of using the system for electronically controlling releasing a quantity of product for shipping including automatically printing a shipping release form which includes a customs release document.

(2) Description of the Related Art

U.S. Pat. No. 5,984,366 to Priddy describes methods and systems for creating and authenticating self-verifying articles such as commercial instruments, transaction cards, personal identification documents, and labels.

U.S. Pat. No. 6,095,919 to Fabel describes a mailing form constructed on a single laminated sheet of standard paper size which is printable by a single pass through a standard non-impact printer.

U.S. Pat. No. 6,203,068 to Petrovsek describes a mailing assembly for use in connection with non-domestic delivery mailpiece wherein the sender of the mailpiece is required to complete a senders declaration. The assembly includes a mailing label, a tracking area, a receipt card, and a backing sheet.

### SUMMARY OF THE INVENTION

When a company ships product to a customer there is a need to insure the correct type and quantity of product is shipped, inventory control is maintained, product flow is controlled, security of product exiting the facility is maintained, and the like. In addition when the product is shipped internationally it is necessary to prepare the required customs declaration forms. These activities usually require a number of paper forms, usually multiple copies of each form, to achieve the desired level of control and security and to produce the required customs declaration forms. These activities also can consume a great deal of labor generating the forms, authenticating the forms, attaching the forms to the proper shipping containers, and the like.

It is a principle objective of at least one embodiment of this invention to provide a method of shipping a quantity of product using computer controlled electronic system to generate shipping requests, control the shipping activity, and to prepare the required forms for shipping.

It is another principle objective of at least one embodiment of this invention to provide a computer controlled electronic system for shipping a quantity of product, controlling the shipping activity, and preparing the required forms for shipping.

These objectives are achieved using a computer controlled electronic shipping release system. A computer is supplied with product release information which is stored in the computer memory. The product release information is updated periodically so it will be current when needed. The computer has a number of user inputs where shipping requests can be initiated. A user; such as a salesperson, customer, engineer, or the like; inputs a request to ship a quantity of product to a particular destination; such as a customer, remote product storage depot, internal testing station, or the like; to the computer through one of the user inputs.

The computer then retrieves required product release information stored in the computer memory and transmits a request for shipping that quantity of product to a product storage unit, such as a warehouse. The product storage unit retrieves the product, sends the product to be prepared for shipping, and transmits information to the computer that it has done so. The computer then updates inventory information and initiates product tracking.

The computer transmits information to a printer regarding the shipping of the quantity of product and instructs the printer to print the required product release form. The product release form will be on a single sheet of paper and will contain any required customs declaration form. The product release form can also include a digital stamp for authentication purposes. The product release form is attached to the quantity of product being prepared for shipping. The quantity of product with the product release form attached is transferred to a product exit control unit. The computer transmits authorization to ship the quantity of product to the product exit control unit. The product exit control unit then allows the quantity of product to ship with the product release form attached and transmits information to the computer to confirm that the quantity of product has been shipped. The product release form contains the customs declaration form when required.

### BRIEF DESCRIPTION OF THE DRAWINGS

FIG. 1 shows a block diagram for the computer controlled electronic system of this invention for shipping a quantity of product.

### DESCRIPTION OF THE PREFERRED EMBODIMENTS

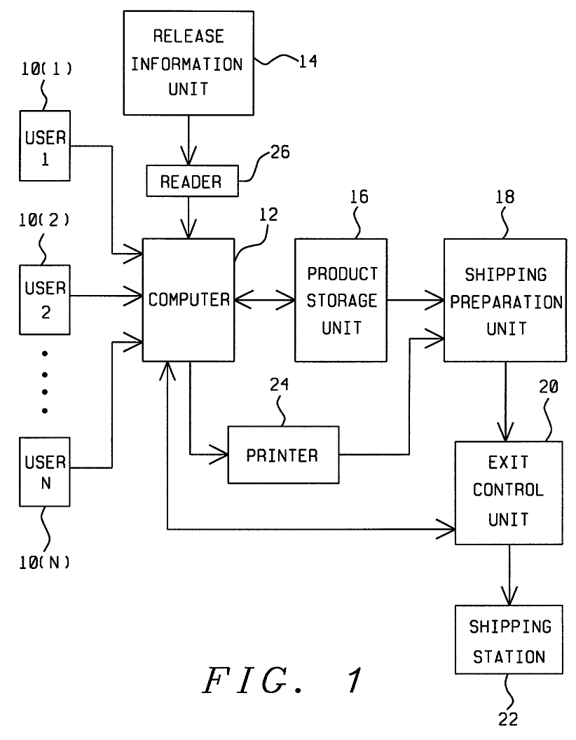

Refer now to FIG. 1 for a detailed description of the computer controlled system of this invention for shipping a quantity of product. FIG. 1 shows a block diagram of the system of this invention. FIG. 1 shows a computer 12 having a memory which is the center of the controlled shipping system and method of this invention. As shown in FIG. 1, the computer 12 has a number of user input stations, 10(1), 10(2), . . . , 10(N) where users can input shipping requests for a particular quantity of a particular product into the computer 12 and can track the progress of shipping of that product. The users can be anyone who can authorize shipping of product such as a salesperson or other company official and could also be a customer entering an order for product. There is a release information source 14 connected to the computer 12 for entering release information into the computer memory. The release information source 14 can be a floppy disk, a magnetic tape, a compact disk, or the like. The computer has an appropriate reader 26, such as a magnetic disk drive, a compact disk drive, or a magnetic tape drive to read the product release information into the computer. The product release information will identify any special controls or special classification for different products and will also provide required information when a customs release form is required.

The product to be shipped is stored in a product storage unit 16 such as a warehouse, an environmentally controlled room, or the like. The product storage unit 16 is in communication with the computer 12 so that information can be transmitted from the computer 12 to the product storage unit 16 or from the product storage unit 16 to the computer 12 using means such as a remote computer terminal. Means for automatically reading product identification information, such as a bar code reader, can also be used. Product selected for shipping is transmitted from the product storage unit 16 to a shipping preparation unit 18 where the selected product is prepared for shipping.

The computer 12 is connected to a printer 24. When product is selected for shipping the computer instructs the printer 24 to print the appropriate product release form. The product release form will include a customs declaration form if desired and will include any desired information on product classification. The product release form can also include a digital stamp to authenticate the form. The product release form is transmitted to the shipping preparation unit 18 where it is attached to the product to be shipped.

The product to be shipped with the product release form attached is then transmitted to the exit control unit 20. The exit control unit 20 is in communication with the computer 12 which transmits instructions to ship the product. The exit control unit 20 verifies the product release form and the computer instructions to ship the product and transmits the product to a shipping station 22 for shipping. The exit control unit 20 transmits the action taken to the computer 22. The exit control unit can comprise a security guard and a remote computer terminal connected to the computer 12. Means for automatically reading product identification, such as a bar code reader, could also be used.

Refer again to FIG. 1 for a description of the method of shipping a quantity of product of this invention. Initially a user transmits a request for shipping a quantity of product to the computer 12 using one of the user input stations 10(1), 10(2), . . . , or 10(N). The user can be anyone who can authorize shipping of product such as a salesman or other authorized employee. An authorized customer could also place an order through the user input stations, 10(1), 10(2), . . . , or 10(N) and the shipping of the product could occur automatically. The shipping request is transmitted to the computer through the user input.

Product release information has been previously stored in the computer 12. The product release information is transmitted to the computer from a product release information source 14. The product release information source can be any storage media such as a magnetic tape, a magnetic disk, or a compact disk. The product release information is read into the computer through an appropriate reader 12 such as a tape reader, a magnetic disk reader, or a compact disk reader. The product release information stored in the computer 12 is updated periodically to remain current. The product release information stored in the computer 12 contains information about special product classification and required customs information if the product is to be shipped internationally.

After the shipping request is transmitted to the computer through the user input station the appropriate information is retrieved from the product release information stored in the computer 12. A shipping request with the appropriate product release information included is then transmitted to a product storage unit 16. The product storage unit can be a warehouse, an environmentally controlled room, or the like. The requested quantity of product is then selected either manually or automatically and transferred to a shipping preparation unit 18. The product storage unit 16 then transmits information regarding the selection of the quantity of product and transfer of the quantity of product to the shipping preparation unit 18 back to the computer 12. Communication between the computer 12 and the product storage unit 16 can be accomplished using manually entered information into a remote computer terminal or can be accomplished by automatic scanners of product identification marks, such as bar codes.

At or about the same time the computer transmits the request for shipping product to the product storage unit the computer 12 transmits information to the printer 24, including appropriate product release information stored in the computer, and instructs the printer 24 to print a product release form. The computer 12 can also transmit a digital authentication stamp to the printer 24 to be printed on the product release form if desired. The computer 12 can also transmit appropriate information for a customs declaration form to the printer 24 to be printed on the product release form if desired. The printer 24 then prints the product release form including a digital authentication stamp, if desired, and a customs declaration form, if desired.

The product release form is transferred to the shipping preparation unit 18 and attached to the quantity of product to be shipped. The quantity of product to be shipped with the product release form attached is then transferred to the exit control unit 20. Before the quantity of product arrives at the exit control unit 20 the computer transmits appropriate information to the exit control unit 20 about the quantity of product to be shipped and the required content of the product release form. The exit control unit 20 verifies the quantity of product to be shipped and the content of product release form and either releases the product to the shipping station 22 or takes appropriate corrective action. The action taken by the exit control unit 20 is transmitted to the computer 12. The exit control unit 20 can comprise a guard or could make use of automatic scanners of product identification marks, such as bar codes. Communication between the computer 12 and the exit control unit 20 can be accomplished using manually entered information into a remote computer terminal or can be accomplished using automatic scanners of product identification marks, such as bar codes. After the product reaches the shipping station 22 it is shipped to its intended destination.

This system minimizes the amount of manual intervention in the shipping cycle and the amount of paper forms required. Digital authentication can replace an authentication stamp and/or signature at manual check points. The entire shipping cycle can be significantly shortened along with significant labor savings. The single product release form contains all the required product information including a customs declaration form. The computer 12, has stored up to date information about the status of the product shipment which can be retrieved at any time through one of the user input stations, 10(1), 10(2), . . . , 10(N).

While the invention has been particularly shown and described with reference to the preferred embodiments thereof, it will be understood by those skilled in the art that various changes in form and details may be made without departing from the spirit and scope of the invention.

What is claimed is:

1. A method of releasing product for shipping, comprising:
providing a computer having a memory and a number of user inputs;
providing a product storage unit;
providing an exit control station;
providing a printer,
providing a product release information source;
feeding product release information into said computer from said product release information source;
storing said product release information in said computer memory;
entering a shipping request into one of said user inputs of said computer by a user wherein said shipping request comprises instructions to ship a quantity of product to a customer;
transmitting instructions from said computer to said product storage unit, said printer, and said exit control station to ship said quantity of product;
transmitting product release information related to said quantity of product from said computer memory to said product storage unit, said printer, and said exit control station;
printing a product release form for said quantity of product by said printer using said product release information transmitted to said printer by said computer;
locating said quantity of product in said product storage unit, attaching said product release form, and preparing said quantity of product for shipping;
transporting said quantity of product to said exit control station;
verifying said quantity of product has said product release form attached and is the same said quantity of product identified by shipping request at said exit control station; and
shipping said quantity of product if said quantity of product has said product release form attached and is the same said quantity of product identified by said shipping request.

2. The method of claim 1 further comprising taking corrective action if said quantity of product does not have said product release form attached or is not the same said quantity of product identified by said shipping request.

3. The method of claim 1 further comprising transmitting confirmation of shipping said quantity of product or a corrective action taken to said computer.

4. The method of claim 1 wherein said product storage unit is a warehouse.

5. (canceled)

6. The method of claim 1 wherein said transmitting said product release information to said printer includes instructions to print a digital stamp on said product release form.

7. The method of claim 1 wherein said product release form includes a digital stamp.

8. The method of claim 1 wherein said product release form includes a customs declaration.

9. (canceled)

10. The method of claim 1 wherein said verifying said quantity of product has said release form attached and is said quantity of product identified by said instructions is accomplished using an electronic scanning system.

11. (canceled)

12. The method of claim 3 wherein said transmitting said confirmation of shipping said quantity of product or said corrective action taken is accomplished using a data terminal connected to said computer.

13. The method of claim 1 wherein said product release information source is a magnetic disk.

14. The method of claim 1 wherein said product release information source is a compact disk.

15. The method of claim 1 wherein said product release information includes information required to produce a digital stamp and a customs declaration form.

16. The method of claim 1 wherein said user is an employee of a unit producing said quantity of product.

17. A system for releasing product for shipping, comprising:
a computer having a memory and a number of user inputs;
a product storage unit wherein said product storage unit has a control unit in communication with said computer,
an exit control station wherein said exit control station has a control unit in communication with said computer;
a printer in communication with said computer;
a product release information source;
means for feeding product release information into said computer memory from said product release information source;
means for entering a shipping request into one of said user inputs of said computer by a user wherein said shipping request comprises instructions to ship a quantity of product to a customer;
means for instructing said printer to print a product release form for said quantity of product;
means for locating said quantity of product in said product storage unit, attaching said product release form to said quantity of product, and preparing said quantity of product for shipping;
means for transporting said quantity of product to said exit control station;
means for verifying said quantity of product has said product release form attached and is the same said quantity of product identified by said shipping request at said exit control station; and
means for shipping said quantity of product if said quantity of product has said product release form attached and is the same said quantity of product identified by said shipping request.

18. The system of claim 17 further comprising means for taking corrective action if said quantity of product does not have said product release form attached or is not the same said quantity of product identified by said shipping request.

19. The system of claim 17 further comprising means for transmitting confirmation of shipping said quantity of product or said corrective action taken to said computer.

20. The system of claim 17 wherein said product storage unit is a warehouse.

21. (canceled)

22. The system of claim 17 wherein said transmitting said product release information to said printer includes instructions to print a digital stamp on said product release form.

23. The system of claim 17 wherein said transmitting said product release information to said printer includes instructions to print a customs declaration on said product release form.

24. (canceled)

25. The system of claim 17 wherein said means for verifying said quantity of product has said release form attached and is said quantity of product identified by said instructions comprises an electronic scanning system.

26. (canceled)

27. The system of claim 19 wherein said means for said transmitting confirmation of shipping said quantity of product or said corrective action taken comprises a data terminal connected to said computer.

28. The system of claim 17 wherein said product release information source is a magnetic disk.

29. The system of claim 17 wherein said means for feeding product release information into said computer memory comprises a magnetic disk reader.

30. The system of claim 17 wherein said product release information source is a compact disk.

31. The system of claim 17 wherein said means for feeding product release information into said computer memory comprises a compact disk reader.
